(19) United States
(12) Patent Application Publication
(10) Pub. No.: US 2003/0151272 A1
(43) Pub. Date: Aug. 14, 2003

(54) Window glass and automobile equipped with the same

(76) Inventors: Akiyoshi Sugimoto, Fujieda-shi (JP); Yoshiaki Inagaki, Shizuoka-shi (JP)

Correspondence Address: KANESAKA AND TAKEUCHI, Suite 2, 1423 Powhatan Street, Alexandria, VA, 22314, US

(21) Appl. No.: 10/356,525

(22) Filed: Feb. 3, 2003

(30) Foreign Application Priority Data
Feb. 8, 2002 (JP) 2002-032972

(51) Int. Cl. B60J 1/08

(52) U.S. Cl. 296/146.2; 296/97.2

(57) ABSTRACT

A door window glass is used for an automobile having a door mirror. The window glass includes a transparent portion at a mirror watching portion through which a driver can see the door mirror, and a light adjusting portion located other than the transparent portion. The light adjusting portion has a light adjusting function for adjusting an intensity of light passing through the door window glass.

### BACKGROUND OF THE INVENTION AND RELATED ART STATEMENT

The present invention relates to a window glass for an automobile and an automobile equipped with the same. The automobile of the invention is designed in particular to facilitate driving safety by reducing the sunlight transmitted through the window glass.

In an automobile, a sun visor is generally used to block the sunlight through a window by a hand. However, the lowering and lifting actions of the sun visor during driving may be troublesome and can be distraction to driving.

In order Lo solve the above-mentioned problems, an automobile window glass can be formed of a light adjusting material for automatically adjusting the light according to an intensity of the ultraviolet light (refer to Japanese Patent Publication (KOKAI) No. 58-49514 and Japanese Utility Model Publication (KOKAI) No. 03-37016).

Additionally, a door mirror with the above-mentioned approach has been described in Japanese Patent Publication (KOKAI) No. 02-171316 (hereinafter referred to as Patent Publication).

In this Patent Publication, an automobile is provided with a light adjusting window for blocking the ultraviolet and includes a door mirror in order to be able to drive without distraction. In a right column from line 7 to line 13 on page 2 of this Patent Publication, there is a description that “In the area 4 at the upper portion of the window, distribution of photochromic ink is made higher. In the area 5 at the lower portion of the window, a less amount of photochromic ink is applied to adjust the photochromic effect to secure transparency, thereby preventing dazzle of the direct sunlight and obtaining an adequate visual field at night”. Also, in a left column from line 35 to line 37 on page 2, there is a description that “even if this film is attached to the front seat side of the window, visibility of the door mirror with which the number of vehicles provided has been increasing in recent years will not be disturbed”.

In the above Patent Publication, since the lower part 5 has a lower concentration of ink to adjust the photochromic effect to secure the transparency, the dazzle of the direct sunlight is prevented and the visual field at night can be adequately maintained. However, when the car moves from a light place to a dark place (for example, a tunnel, shade, etc.) during driving, “adaptation to darkness” of the human eyes themselves occurs slowly, thereby making it difficult to retain visibility. Also, due to a poor response of photochromic ink (ink takes longer time to respond to become lighter as compared to a situation when the color becomes darker), photochromic ink dose not turn to be transparent immediately. In addition, because the surrounding area is dark, visibility of the door mirror is disturbed, and in particular, it can cause fatal problems during driving at a high speed.

The present invention has been made to provide a window glass for an automobile in order to solve the above-mentioned condition, wherein the sunlight through a predetermined area is blocked while driving, so that the driver can drive comfortably.

Another object of the invention is to provide an automobile with the window glass as stated above.

Further objects and advantages of the invention will be apparent from the following description of the invention.

### SUMMARY OF THE INVENTION

A window glass of an automobile includes the first portion of the window glass located at a predetermined area and formed of a light adjusting material for automatically adjusting an intensity of light; and the second portion of the window glass located at an area other than the predetermined area, for example, an area through which a driver see a door mirror or below the driver eyes, or one third of a window height from the top, and formed of a non-light adjusting material to be transparent.

The light adjusting material for automatically adjusting the intensity of the light according to intensity of ultraviolet light includes a material used for photochromic lenses.

With the configuration described above, the sunlight through the predetermined area is blocked while driving, so that the driver can drive comfortably. Other area, for example, the lower portion of the window glass located below the driver eyes, is transparent. Thus, even when the car moves from a light place to a dark place, for example, into a tunnel, the driver can have a secure visibility and can continue to drive without a trouble.

In the front glass described above, a photochromic layer may be disposed. The photochromic layer is formed of a coating or a film of the light adjusting material for automatically adjusting the light intensity.

In the automobile according to the present invention, a door window glass is provided with an upper portion located above the driver eyes and formed of the light adjusting material for automatically adjusting the intensity of the light. Also, a lower portion of the door glass located below the driver eyes is transparent without using the light adjusting material.

In the door window glass described above, a photochromic layer may be disposed. The photochromic layer is formed of a coating or a film of the light adjusting material for automatically adjusting the light intensity.

### BRIEF DESCRIPTION OF THE DRAWINGS

FIG. 1 is a schematic perspective view showing an automobile according to an embodiment of the invention;

FIG. 2 is a schematic side view showing an automobile in FIG. 1;

FIG. 3 is a schematic view seen from the inside of the automobile in FIG. 1;

FIG. 4 is a schematic perspective view showing an automobile of another embodiment of the invention;

FIG. 5 is a schematic view seen from the inside of the automobile in FIG. 4;

FIG. 6 is a schematic perspective view showing an automobile of a further embodiment of the invention;

FIG. 7 is a schematic view seen from the inside of the automobile in the FIG. 6;

FIG. 8 is a schematic perspective view showing an automobile of a still further embodiment of the invention; and

FIG. 9 is a schematic view seen from the inside of the automobile in the FIG. 8.

### DETAILED DESCRIPTION OF THE PREFERRED EMBODIMENTS

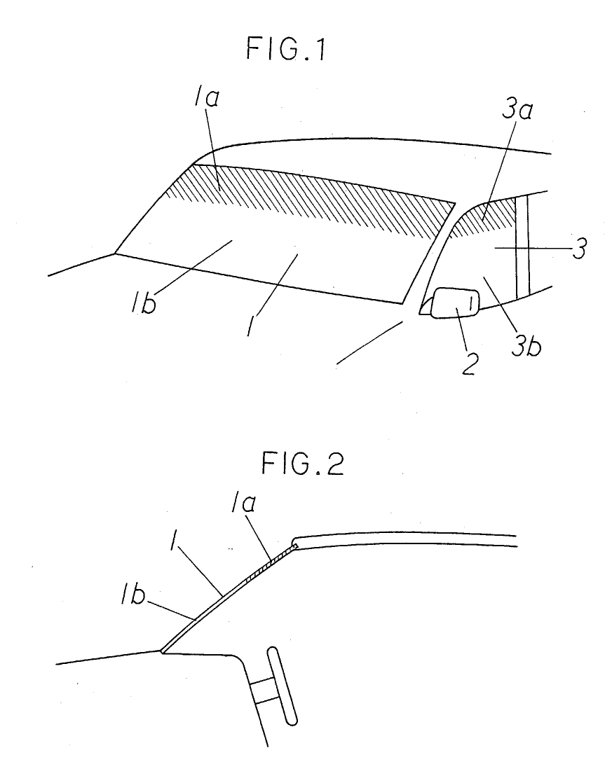

Hereunder, embodiments of the present invention will be explained with reference to the accompanying drawings. In FIG. 1, a front window glass 1 of an automobile includes an upper part la of the front glass 1 located above the driver eyes, or one third of a window height from the top, and formed of a light adjusting material for automatically adjusting an intensity of light transmitted through the front window according to an intensity of ultraviolet light; and a lower portion 1b of the front window glass 1 located below the driver eyes and including no light adjusting material to be transparent.

The light adjusting material that can adjust automatically the light intensity according to the ultraviolet light includes, for example, a material used for photochromic lenses. More specifically, photochromic goods have been disclosed in Japanese Patent Publication (KOKOKU) No. 40-11944, using a silica type glass film “Heatless glass” manufactured by Nikko Kabushiki kaisha.

The intensity of sunlight is reduced by the upper portion with the light adjusting material (shown as 1a in the front glass 1) while driving, so that the driver can drive comfortably and even if the driver moves from a light place to a dark place, for example, into a tunnel, the driver can keep visibility and drive without trouble because the lower portion 1b of the front glass 1 located below the driver eyes does not include the light adjusting material and is transparent.

In the above-embodiment, the front window glass 1 includes the upper part with the light adjusting material and the lower part without the light adjusting material. Alternatively, the front glass 1 is formed of a material without light adjusting material. A photochromic layer, which, for example, is formed of coating or a film of the light adjusting material, may be disposed on the upper portion of the front window glass. The lower portion of the front window glass maintains the transparency, thereby obtaining the same effect as the previous embodiment.

In the above-embodiment, a part of the front glass 1 has the light adjusting function according to the intensity of the ultraviolet light. Further, a door window glass 3 may have the light adjusting function for automatically adjusting the light intensity according to the ultraviolet rays. In the door glass 3, at least a part 3b of the door glass 3, through which a driver sees a door mirror 2, can be transparent without the light adjusting function.

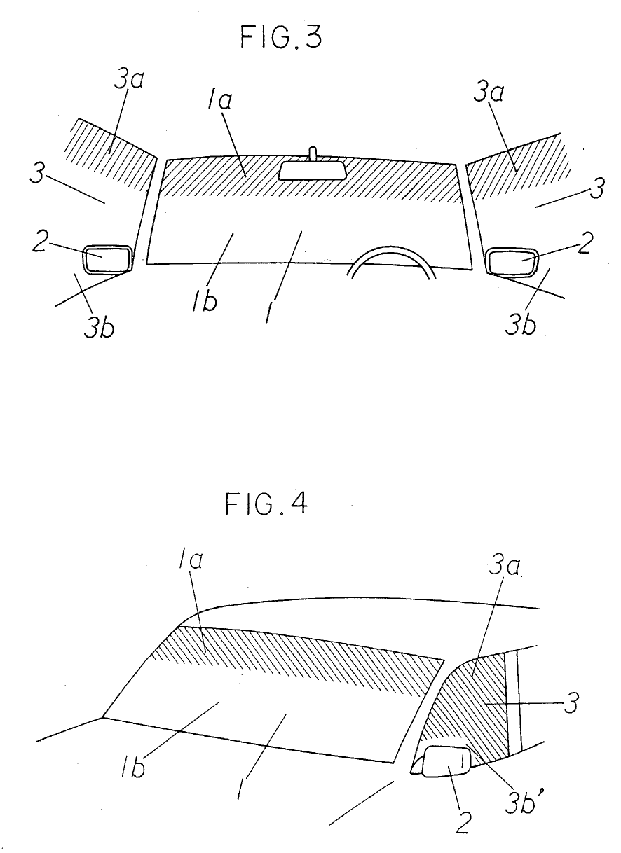

As shown in FIGS. 1 and 3, in the automobile having the door mirror 2, a part 3a of the door glass 3 located above the driver eyes can be formed of the light adjusting material for automatically adjusting the light intensity according to the ultraviolet rays, and a part 3b of the door glass 3 located below the driver eyes is transparent without the light adjusting material. In other words, according to the invention, the automobile of the embodiment is a combination (A) having the door mirror 2, B) the whole part 3a of the door glass 3 located above the driver eyes is formed of the light adjusting material for automatically adjusting the light according to the ultraviolet rays, and (C) the part 3b of the door glass 3 located below the driver eyes is transparent without the light adjusting material. Accordingly, the whole part of the door glass 3 located below the driver eyes is transparent without the light adjusting material.

Thus, when the car moves from a light place to a dark place (for example, a tunnel, shade, etc.) while a driver is driving the car, the driver's response will be delayed due to the “dark adaptation” of the human eyes themselves and the driver will have a difficulty in securing visibility. However, even in the above case, the embodiment of the invention provides an effect so that the driver can see the door mirror 2 through the door glass 3 and can secure visibility, thereby preventing difficulty of driving. In order to secure the visibility when a driver moves from a light place to a dark place (for example, a tunnel, shade, etc.) while driving, the whole part 3b of the door glass 3 located below the driver eyes is provided to be transparent without the light adjusting material, so that it can not only secure visibility of the door mirror 3, but also other drivers or pedestrians can see the driver's action. In other words, if the driver's action can be seen, other drivers or pedestrians can easily react depending on whether the driver is paying attention to other drivers or pedestrians, thereby resulting in an incidental effect for preventing an accident.

In addition, as shown in FIGS. 4 and 5, in the door glass 3, at least the part 3b′ of the door glass 3, through which the driver sees the door mirror 2, can be transparent without the light adjusting function, and the other part 3a of the door glass 3 except for the part 3b′ of the door glass 3 can be formed of the light adjusting material for automatically adjusting the light according to the ultraviolet rays.

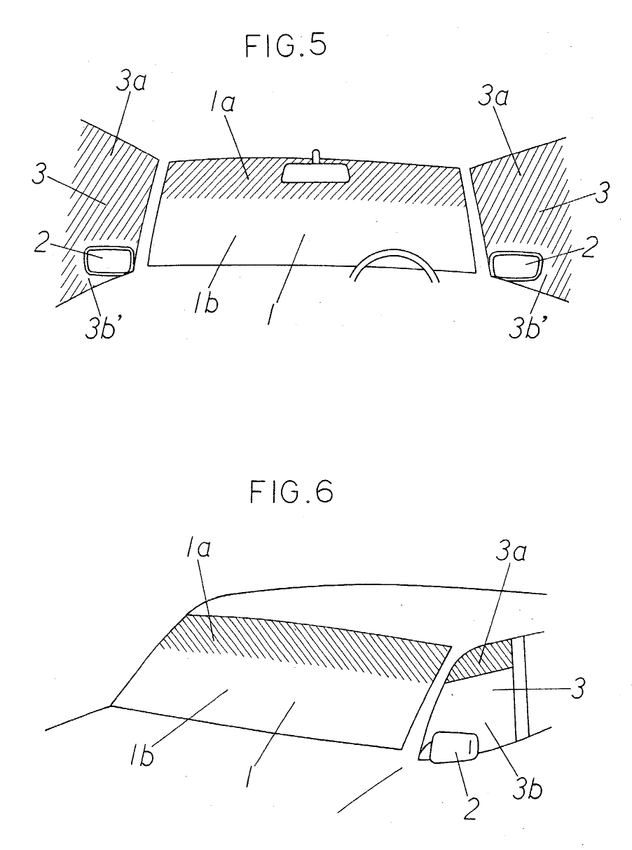

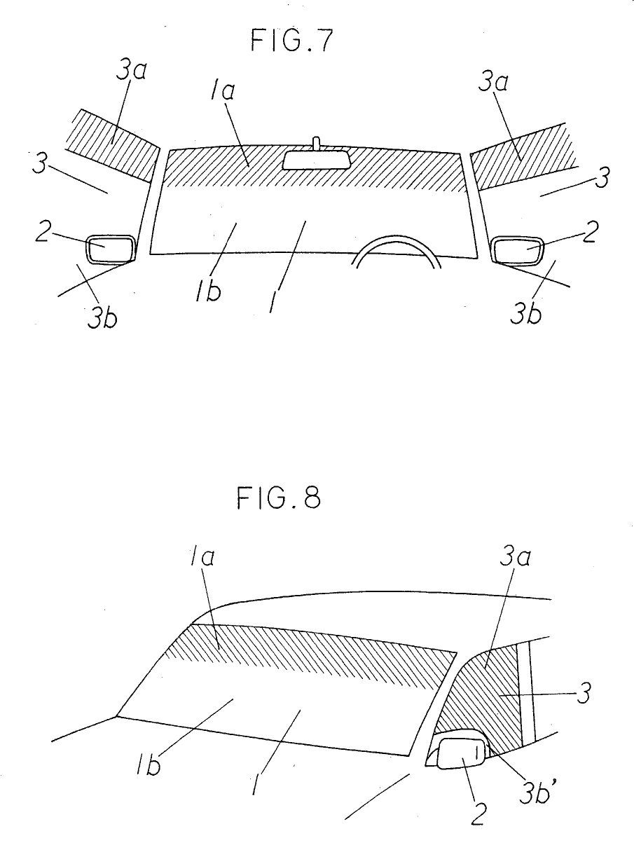

In the above-embodiment, the door glass 3 includes the light adjusting part and the non-light adjusting part. Alternatively, the door glass itself 3 may not have the light adjusting function. In the door glass 3, the whole part of the door glass 3 located above the driver eyes may be provided with a light adjusting layer formed of the light adjusting material for automatically adjusting the light according to the ultraviolet rays. For example, as shown in FIGS. 6 and 7, a light adjusting layer is formed of a coating of the light adjusting material for automatically adjusting the light according to the ultraviolet rays, or is attached to a film of the light adjusting material for automatically adjusting the light according to the ultraviolet rays. The part 3b of the door glass 3 located below the driver eyes is transparent without the light adjusting material, thereby obtaining the same effect as the above-embodiment.

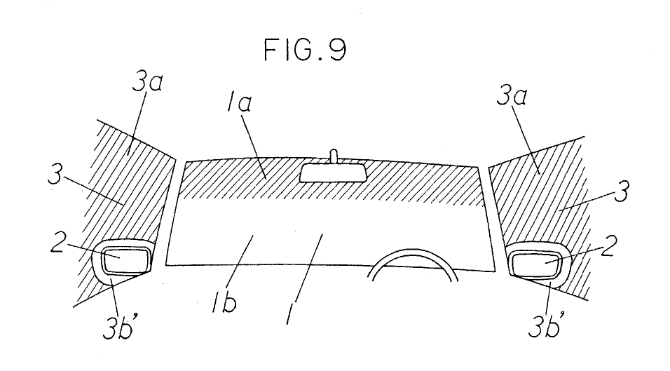

Also, as shown in FIGS. 8 and 9, only the part 3b′ of the door glass 3, through which the driver sees the door mirror 2, may be transparent without the light adjusting function. In other part 3a of the door glass 3 (the door glass 3 except for the part 3b′), the light adjusting layer formed of the light adjusting material may be disposed for automatically adjusting the light according to the ultraviolet rays.

While the invention has been explained with reference to the specific embodiments of the invention, the explanation is illustrative and the invention is limited only by the appended claims.

What is claimed is:

1. A door window glass for an automobile having a door mirror, comprising:
a transparent portion including a mirror watching portion through which a driver can see the door mirror, and
a light adjusting portion other than the transparent portion having a light adjusting function for adjusting an intensity of light passing through the door window glass.

2. A door window glass according to claim 1, wherein said light adjusting portion is formed of a light adjusting material integrally formed with the window glass for adjusting the intensity of the light passing through the door window glass.

3. A door window glass according to claim 2, wherein said light adjusting portion formed of the light adjusting material is entirely formed generally above one third of the door window glass and said transparent portion is entirely located generally below the one third of the door window glass.

4. A door window glass according to claim 1, wherein said light adjusting portion is provided with a layer formed of a light adjusting material for adjusting the intensity of the light passing through the door window glass.

5. A door window glass according to claim 4, wherein said light adjusting portion provided with the layer is entirely located generally above one third of the door window glass and said transparent portion is entirely located generally below the one third of the door window glass.

6. A door window glass according to claim 1, wherein said transparent portion is located only at the mirror watching portion through which the driver can see the door mirror, a portion other than the mirror watching portion is the light adjusting portion.

7. An automobile comprising the door window glass according to claim 1.
